(19) United States
(12) Patent Application Publication
(10) Pub. No.: US 2025/0108647 A1
(43) Pub. Date: Apr. 3, 2025

(54) RECORDING DEVICE

(71) Applicant: SEIKO EPSON CORPORATION, Tokyo (JP)

(72) Inventors: Takehiro SHIN, SHIOJIRI-SHI (JP); Kazutoshi MATSUZAKI, SHIOJIRI-SHI (JP)

(21) Appl. No.: 18/901,846

(22) Filed: Sep. 30, 2024

(30) Foreign Application Priority Data
Oct. 2, 2023 (JP) 2023-171461

(51) Int. Cl. B41J 29/13; B41J 3/60; B41J 11/00; B41J 13/03; B41J 13/08; B41J 29/17; B65H 37/00; B65H 85/00

(52) U.S. Cl. CPC B41J 29/13; B41J 3/60; B41J 11/0015; B41J 11/006; B41J 13/03; B41J 13/08; B41J 29/17; B65H 37/00; B65H 85/00; B65H 2301/5133; B65H 2801/12; B65H 2801/15

(57) ABSTRACT

The recording device includes a door section that opens a part of the transport path by opening it and forms the part of the transport path and by closing it. The door section has a first path forming section that forms a part of the transport path, a first roller pair that nips and transports a medium, and a second roller pair that nips and transports a medium, the first roller pair and the second roller pair maintain a nipped state when the door section is opened or closed, when the door section is opened, at least a part of the path section between the first roller pair and the second roller pair is opened in the transport path, and a path length between the first roller pair and the second roller pair is shorter than a transport direction length of a smallest size of medium that is recordable.

The present application is based on, and claims priority from JP Application Serial Number 2023-0171461, filed Oct. 2, 2023, the disclosure of which is hereby incorporated by reference herein in its entirety.

### BACKGROUND

### 1. Technical Field

The present disclosure relates to a recording device that performs recording on a medium.

### 2. Related Art

In a recording device represented by an ink jet printer, an opening and closing section may be provided to open a medium transport path, as shown in JP-A-2023-091921.

When the opening and closing section is opened, the medium transport path is opened, and the jammed medium can be removed. In the configuration of the related art as described above, it is possible to remove jammed medium when the opening and closing section is opened, but that is all, and there was room for improvement in terms of usability.

### SUMMARY

To overcome the above problem, a recording device according to the present disclosure includes a device main body having a transport path in which a medium is transported and a recording section that performs recording on a medium in the transport path; a door section that opens and closes a side surface of the device main body, and that opens a part of the transport path by being opened and that forms a part of the transport path by being closed, wherein the door section has a first path forming section that forms a part of the transport path, a first roller pair that nips and transports a medium, and a second roller pair that is located below or above the first roller pair and that nips and transports a medium, the first roller pair and the second roller pair maintain a nipped state when the door section is opened or closed, when the door section is opened, at least a part of a path section between the first roller pair and the second roller pair is opened in the transport path, and a path length between the first roller pair and the second roller pair is shorter than a transport direction length of a smallest size of medium that is recordable.

### BRIEF DESCRIPTION OF THE DRAWINGS

FIG. 1 is a diagram showing a medium transport path of a printer.

FIG. 2 is an external perspective view of the printer when a door section is closed.

FIG. 3 is an external perspective view of the printer when the door section is opened.

FIG. 4 is a perspective view of a support unit in a closed state.

FIG. 5 is a perspective view of the support unit in an open state.

FIG. 6 is a perspective view of an operation section for releasing a lock of the support unit.

FIG. 7 is a perspective view of a first section provided in the support unit.

FIG. 8 is a perspective view of a contact section and a pressing section provided on the door section.

FIG. 9 is a cross-sectional view of a belt unit.

FIG. 10 is a diagram showing each path forming section that forms a guide path, a switchback path, and an inversion path.

FIG. 11 is another diagram showing each path forming section that forms the guide path, the switchback path, and the inversion path.

FIG. 12 is a cross-sectional view of a first member, a second member, and a flap.

FIG. 13 is a perspective view of the first member, the second member, and the flap.

FIG. 14 is an enlarged view of a portion A of FIG. 13.

FIG. 15 is an enlarged view of a portion B of FIG. 13.

FIG. 16 is an enlarged view of a portion C of FIG. 13.

FIG. 17 is a partially enlarged perspective view of a second member.

FIG. 18 is a perspective view of a portion where the first member and the second member are engaged.

### DESCRIPTION OF EMBODIMENTS

Hereinafter, the present disclosure will be briefly described.

A recording device according to a first aspect includes a device main body having a transport path in which a medium is transported and a recording section that performs recording on a medium in the transport path; a door section that opens and closes a side surface of the device main body, and that opens a part of the transport path by being opened and that forms a part of the transport path by being closed, wherein the door section has a first path forming section that forms a part of the transport path, a first roller pair that nips and transports a medium, and a second roller pair that is located below or above the first roller pair and that nips and transports a medium, the first roller pair and the second roller pair maintain a nipped state when the door section is opened or closed, when the door section is opened, at least a part of a path section between the first roller pair and the second roller pair is opened in the transport path, and a path length between the first roller pair and the second roller pair is shorter than a transport direction length of a smallest size of medium that is recordable.

According to this aspect, the first roller pair and the second roller pair maintain the nip state when the door section is opened or closed, and the path length between the first roller pair and the second roller pair is shorter than a transport direction length of a smallest size of medium that is recordable. By this, a medium is nipped by at least one of the first roller pair and the second roller pair when the door section is opened. Therefore, it is possible to suppress a medium from unintentionally falling out.

Here, when the door section is opened, if the path section between the first roller pair and the second roller pair in the transport path remains closed state over the entire area, visibility of jammed medium is reduced, and it is difficult to remove the jammed medium. However, according to this aspect, when the door section is opened, at least a part of the path section between the first roller pair and the second roller pair in the transport path is open. Therefore, it is possible to improve visibility of jammed medium and to easily remove the jammed medium. By this, usability of the recording device can be improved.

Note that when the term “at least a part” is used in this specification, it may be either a part or the whole.

A second aspect is an aspect according to the first aspect, wherein the device main body has a support section that is provided at a position facing the recording section and that is configured to support a medium on which recording is performed by the recording section, the support section has a second path forming section that forms a part of the transport path at a position facing the first path forming section, and by the door section being opened, a space between the first path forming section and the second path forming section is opened.

According to this aspect, a space between the first path forming section and the second path forming section is opened by opening the door section. Therefore, it is possible to remove a medium that was jammed between the first path forming section and the second path forming section. By this, usability of the recording device can be improved.

A third aspect is an aspect according to the second aspect, wherein the door section has a third path forming section that forms a part of the transport path at a position different from the first path forming section and a fourth path forming section that at least partly faces the third path forming section and forms a part of the transport path, the first roller pair is disposed in a part of the transport path that is formed by the third path forming section and the fourth path forming section.

According to this aspect, in the configuration in which the first roller pair is disposed in a part of the transport path that is formed by the third path forming section and the fourth path forming section, the operation and effect of the first aspect described above are obtained.

A fourth aspect is an aspect according to the third aspect, wherein a path length of the part of the transport path that is formed by the third path forming section and the fourth path forming section is shorter than a path length of a part of the transport path that is formed by the first path forming section and the second path forming section and that is opened by opening the door section.

A part of the transport path formed by the third path forming section and the fourth path forming section is a section that is not opened even when the door section is opened.

According to this aspect, a path length of the section that is not opened by opening the door section is shorter than a path length of the section that is opened by opening the door section. Therefore, it is possible to suppress the medium from falling out when opening the door section and to secure visibility of jammed medium. As a result, usability of the recording device can be improved.

A fifth aspect is an aspect according to the third aspect, wherein a path length of the part of the transport path that is formed by the third path forming section and the fourth path forming section is shorter than a transport direction length of a smallest size of medium that is recordable.

According to this aspect, a path length of the section that is not opened by opening the door section is shorter than a transport direction length of a smallest size of the medium that is recordable. Therefore, regardless of the transport direction length of the medium, a medium that is jammed between the third path forming section and the fourth path forming section can be visually recognized and can be removed. As a result, usability of the recording device can be improved.

Note that this aspect is not limited to the third aspect above, and may be according to the fourth aspect above.

A sixth aspect is an aspect according to the third aspect, wherein the transport path has a switchback path that is used for switchback transport of a medium that passed between the recording section and the support section, a guide path that guides the medium that passed between the recording section and the support section to the switchback path, and an inversion path that is connected to the switchback path and that inverts the medium, the fourth path forming section forms at least a part of the guide path and at least a part of the inversion path, and the first path forming section and the second path forming section form at least a part of the inversion path at a downstream side of the third path forming section in the transport direction.

According to this aspect, the fourth path forming section forms at least a part of the guide path and at least a part of the inversion path. Therefore, it is possible to reduce a size of the device by sharing the same members. As a result, the recording device can be easily handled, and usability of the recording device can be improved.

Note that this aspect is not limited to the third aspect above, and may be according to the fourth or fifth aspect above.

A seventh aspect is an aspect according to the sixth aspect, wherein the fourth path forming section has a first member and a second member that is connected to the first member, wherein a charge removal brush that removes charge from a medium is provided in a state of being sandwiched between the first member and the second member.

According to this aspect, the charge removal brush, which removes charge from the medium, can be provided in a state it is sandwiched between the first member and the second member, so that the charge removal brush can be easily assembled and provided.

An eighth aspect is an aspect according to the sixth aspect, further including a switching section that is configured to switch between a state in which a medium is guided from the guide path to the switchback path and a state in which a medium is guided from the switchback path to the inversion path, wherein the fourth path forming section has a plurality of support shaft sections that pivotably support the switching section along the medium width direction that intersects a medium transport direction, the switching section has a first engagement section that restricts movement of the switching section in a first direction, where the medium comes into contact with the switching section, by engaging with the support shaft sections and a second engagement section that restricts movement of the switching section in a second direction, which is an opposite direction to the first direction, by engaging with the support shaft sections, wherein the switching section is pivotably engaged with the support shaft sections by sandwiching the support shaft sections between the first engagement section and the second engagement section, the first engagement section and the second engagement section are provided in plurality along the medium width direction, and the number of the second engagement sections is less than the number of the first engagement sections.

If the number of the second engagement sections is the same as the number of the first engagement sections, there is a concern that workability when the switching section is engaged with the support shaft section is reduced and that smooth swinging of the switching section cannot be secured due to an increase in friction resistance when the switching section is fitted to the support shaft section.

However, according to this aspect, the number of second engagement sections is less than the number of first engagement sections. Therefore, it is possible to suppress a decrease in workability when the switching section is engaged with the support shaft section, and to suppress an increase in friction resistance when the switching section is fitted to the support shaft section. Although the switching section may be deformed in the first direction due to the medium coming into contact with the switching section, since the first engagement section is provided more than the second engagement section, the deformation can be effectively suppressed.

Note that this aspect is not limited to the sixth aspect above, and may be according to the seventh aspect above.

A ninth aspect is an aspect according to the sixth aspect, further including a switching section that is configured to switch between a state in which a medium is guided from the guide path to the switchback path and a state in which a medium is guided from the switchback path to the inversion path, wherein the fourth path forming section has a plurality of support shaft sections that pivotably support the switching section along the medium width direction that intersects a medium transport direction, the switching section has a first engagement section that restricts movement of the switching section in a first direction, where the medium comes into contact with the switching section, by engaging with the support shaft sections and a second engagement section that restricts movement of the switching section in a second direction, which is an opposite direction to the first direction, by engaging with the support shaft sections, wherein the switching section is pivotably engaged with the support shaft sections by sandwiching the support shaft sections between the first engagement section and the second engagement section, the first engagement section and the second engagement section are provided in plurality along the medium width direction, and the first engagement sections are provided at a center and both ends of the switching section in the medium width direction, and the second engagement sections are provided at both ends of the switching section in the medium width direction.

If the number of the second engagement sections is the same as the number of the first engagement sections, there is a concern that workability when the switching section is engaged with the support shaft section is reduced and that smooth swinging of the switching section cannot be secured due to an increase in friction resistance when the switching section is fitted to the support shaft section.

However, according to this aspect, the number of second engagement sections is less than the number of first engagement sections. Therefore, it is possible to suppress a decrease in workability when the switching section is engaged with the support shaft section, and to suppress an increase in friction resistance when the switching section is fitted to the support shaft section.

Although the switching section may be deformed in the first direction due to the medium coming into contact with the switching section, since the first engagement sections are provided at the center and the both ends of the switching section in the medium width direction, it is possible to suppress the deformation.

Note that this aspect is not limited to the sixth aspect above, and may be according to the seventh aspect above.

A tenth aspect is an aspect according to any one of the second to ninth aspects, wherein the support section is configured to switch by pivoting between a first state in which the support section is configured to support a medium to be recorded on by the recording section and a second state in which the support section is further retracted from the recording section than in the first state and has an operation section that releases a state of holding the support section in the first state, and the second path forming section has a guide section that guides a user's finger to the operation section.

According to this aspect, by switching the support section from the first state to the second state, it is possible to easily remove a medium when the medium is jammed at a position facing the recording section.

The second path forming section is equipped with the guide section that guides the user's finger to the operation section, so that usability is improved. In addition, the guide section does not need to be provided in a dedicated member, so an increase in cost of the device can be suppressed.

An eleventh aspect is an aspect according to the tenth aspect, wherein the support section has a transport belt that transports a medium and the transport belt transports a medium in a direction that intersects with a horizontal direction and a vertical direction.

According to this aspect, the transport belt transports the medium in a direction that intersects the horizontal direction and the vertical direction. Therefore, it is possible to reduce a size of the recording device in the horizontal direction and the vertical direction.

Since the support section is pivotable, accessibility to the transport belt is improved and usability is enhanced.

A twelfth aspect is an aspect according to any one of the second to ninth aspects, wherein the support section has a transport belt that transports a medium.

According to this aspect, in a configuration in which the support section has a transport belt that transports a medium, operation and effect of any one of the first to ninth aspects described above can be obtained.

A thirteenth aspect is an aspect according to the twelfth aspect, wherein the support section has a cleaning section that performs cleaning of the transport belt and as viewed in a direction that intersects with an outer surface of the door section, the transport belt and the cleaning section enter into a region of the second path forming section.

According to the aspect, as viewed in the direction intersecting the outer surface of the door section, the transport belt and the cleaning section enter in the region of the second path forming section. Therefore, it is possible to suppress the user from carelessly accessing the transport belt or the cleaning section and soiling their fingers. In addition, there is no need to provide a dedicated member that covers the transport belt and the cleaning section, so that an increase in cost of the device can be suppressed.

A fourteenth aspect is an aspect according to the thirteenth aspect, wherein the cleaning section has a paper dust collection container that collects paper dust from the transport belt and as viewed in a direction that intersects the outer surface of the door section, the second path forming section covers the paper dust collection container.

According to this aspect, as viewed in the direction intersecting the outer surface of the door section, the second path forming section covers the paper dust collection container. Therefore, it is possible to suppress the user from carelessly accessing the paper dust collection container and scattering paper dust, when the door section is opened. In addition, it is not necessary to provide a dedicated member that covers the paper dust collection container, and an increase in cost of the device can be suppressed.

A fifteenth aspect is an aspect according to any one of the second to ninth aspects, wherein the support section is configured to switch by pivoting between a first state in which the support section is configured to support a medium to be recorded on by the recording section and a second state in which the support section is further retracted from the recording section than in the first state and the door section has a contact section that switches the support section to the first state by contacting the support section while the door section is closing from a state in which the door section is open and the support section is in the second state.

According to this aspect, even when the door section is closed while the support section is in the second state, the door section switches the support section from the second state to the first state. Therefore, usability is improved.

A sixteenth aspect is an aspect according to any one of the second to ninth aspects, wherein the support section is configured to switch by pivoting between a first state in which the support section is configured to support a medium to be recorded on by the recording section and a second state in which the support section is further retracted from the recording section than in the first state and the door section has a pressing section that presses the support section toward the first state.

According to this aspect, the door section has the pressing section that presses the support section toward the first state. Therefore, it is possible to appropriately maintain the support section in the first state. As a result, a distance between the support section and the recording section is appropriately maintained, and a decrease in recording accuracy can be suppressed.

A seventeenth aspect is an aspect according to the sixteenth aspect, wherein the door section has a contact section that switches the support section to the first state by contacting the support section while the door section is closing from a state in which the door section is open and the support section is in the second state and in conjunction with a close operation of the door section, the contact section transitions from a state in which the contact section is in contact with the support section to a state in which the pressing section presses the support section.

According to this aspect, the close operation of the door section causes a transition from a state in which the contact section contacts the support section to a state in which the pressing section presses the support section. By this, by the close operation of the door section, switching of the support section to the second state and pressing of the support section by the pressing section can be achieved.

In addition, the positions of the contact section and the pressing section can be brought closer to each other, so that a size of the device can be reduced.

The eighteenth aspect is an aspect according to the seventeenth aspect, wherein the contact section holds the pressing section.

According to this aspect, since the contact section holds the pressing section, it is possible to reduce a size of the device and to suppress an increase in cost compared to a configuration in which the pressing section is held by a dedicated member.

A nineteenth aspect is an aspect according to the seventeenth aspect, wherein the support section has a first section that engages with the contact section and the pressing section and the door section has a guide section that guides the first section from the pressing section to the contact section when the door section is opened and the first section transitions from a state in which the first section is in contact with the pressing section to a state in which the first section comes into contact with the contact section.

In a configuration in which a state where the contact section is in contact with the first section transitions to a state where the pressing section presses the first section by the close operation of the door section, the door section may not be completely closed and then may be opened again. In this case, the first section attempts to move from a state in which the first section is in contact with the pressing section to a state in which the first section is in contact with the contact section. However, at this time, there is a concern that the first section may get caught in the contact section.

According to this aspect, the door section has the guide section that guides the first section from the pressing section to the contact section. Therefore, when the door section is opened and the first section transitions from a state in which the first section is in contact with the pressing section to a state in which the first section is in contact with the contact section, it is possible to suppress the catching above.

Note that this aspect is not limited to the seventeenth aspect above, and may be according to the eighteenth aspect above.

A twentieth aspect is an aspect according to the seventeenth aspect, wherein the support section has a transport belt that transports a medium and the transport belt transports a medium in a direction that intersects with a horizontal direction and a vertical direction.

According to this aspect, the transport belt transports the medium in a direction that intersects the horizontal direction and the vertical direction. Therefore, it is possible to reduce a size of the recording device in the horizontal direction and the vertical direction.

Since the support section is pivotable, accessibility to the transport belt is improved and usability is enhanced.

In a configuration where the transport belt transports a medium in a direction intersecting the horizontal direction and vertical direction, the support section easily pivots toward the second state due to its own weight. However, it is possible to appropriately maintain the support section in the first state by the pressing section. As a result, a distance between the support section and the recording section is appropriately maintained, and a decrease in recording accuracy can be suppressed.

Note that this aspect is not limited to the seventeenth aspect above, and may be according to the eighteenth or nineteenth aspect above.

Hereinafter, the present disclosure will be specifically described.

Hereinafter, an inkjet printer 1 that performs recording by ejecting ink, which is an example of liquid, onto a medium represented by a recording sheet, will be described as an example of the recording device. Hereinafter, the inkjet printer 1 will be referred to simply as a printer 1. Note that the printer 1 can also be regarded as a medium transport device from the viewpoint of transporting a medium. In this case, the printer 1 is equipped with a medium transport device and a line head 44, which is an example of a recording section (to be described later).

Note that an X-Y-Z coordinate system shown in each drawing is a Cartesian coordinate system. A Y-axis direction is a direction that intersects a transport direction of a medium, that is, a medium width direction, and that is also a depth direction of the device. In the Y-axis direction, a +Y direction is a direction from a device front surface toward a device rear surface, and a −Y direction is a direction from the device rear surface toward the device front surface.

An X-axis direction is a device width direction. As viewed from the operator of the printer 1, a +X direction is to a left side and a-X direction is to a right side. A Z-axis direction is a vertical direction, and is a normal direction with respect to a placement surface G of the printer 1, that is, a device height direction. In the Z-axis direction, a +Z direction is an upward direction and a −Z direction is a downward direction.

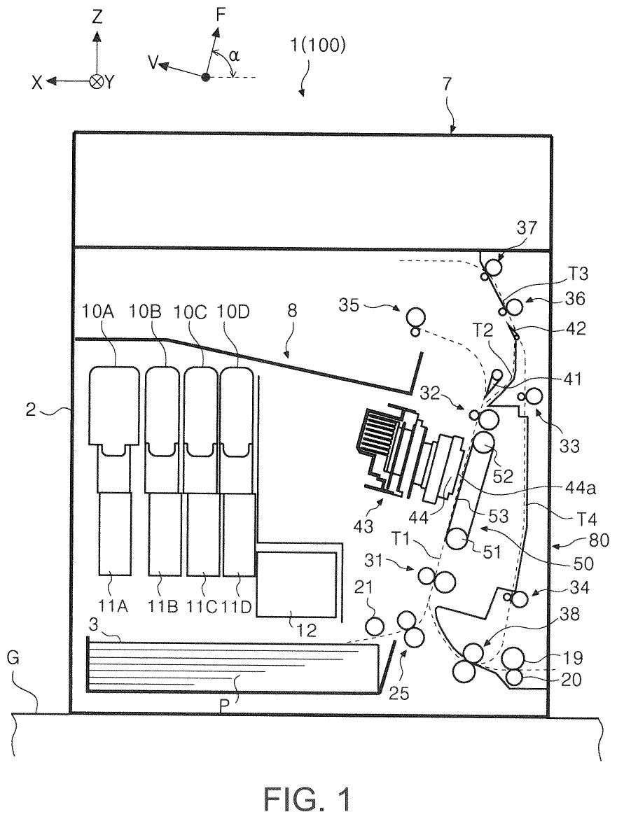

Hereinafter, a direction in which the medium is sent may be referred to as “downstream”, and an opposite direction of it may be referred to as “upstream”. In FIG. 1, a medium transport path is indicated by a broken line. In the printer 1, a medium is transported through a medium transport path indicated by the broken line in FIG. 1.

A F-axis direction is a direction between a line head 44 and a transport belt 53 (to be described later), that is, a medium transport direction in a recording region. A +F direction is downstream in the transport direction, and a −F direction is upstream in the transport direction. A V-axis direction is a direction perpendicular to the F-axis direction.

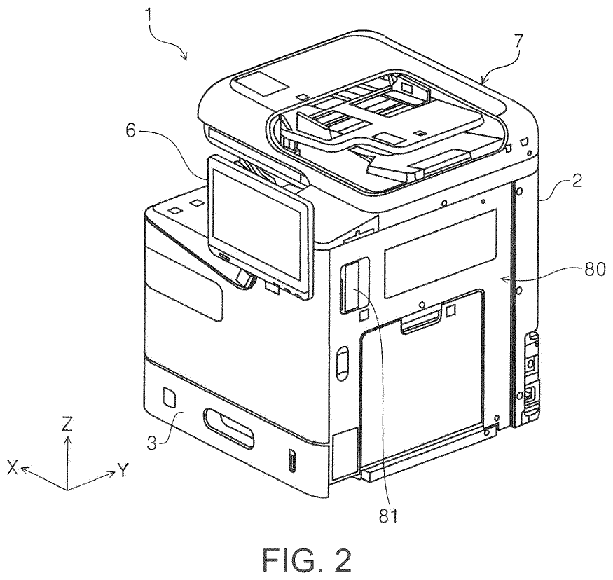

As shown in FIG. 2, the printer 1 is a multifunction device that is provided with a scanner unit 7, which is an example of an image reading device, in an upper portion of the device main body 2. However, the scanner unit 7 may be omitted.

An operation panel 6 for performing various operation settings is provided at an upper portion of the device main body 2. In the printer 1, a −Y direction side surface, which is a side surface on which the operation panel 6 is provided, is a front surface of the device.

The printer 1 is configured so that an additional unit (not shown) can be connected to a lower portion of the device main body 2, and a medium can be fed from this additional unit. However, the additional unit may not be connectable.

The printer 1 has a transport path through which a medium fed from the additional unit is transported.

The device main body 2 has a first medium cassette 3, which accommodates a medium, in a lower portion thereof. The reference symbol P indicates a medium stored in the first medium cassette 3. For the first medium cassette 3, a pickup roller 21 that feeds the stored medium in the −X direction is provided. The medium sent out by the pickup roller 21 is sent toward a transport roller pair 31 by a feed roller pair 25.

Note that in this specification, a roller pair means, unless otherwise specified, a roller pair that nips and transports a medium with two facing rollers.

In the following description, unless specifically described, the “roller pair” is assumed to be composed of a drive roller that applies a feed force to a medium by being driven by a drive source (not shown) and a driven roller that is driven and rotates in contact with the drive roller or the medium.

A medium that receives a feed force from the transport roller pair 31 is sent to a position between the line head 44, which is an example of the recording head, and the transport belt 53, that is, a position facing the line head 44. Note that hereafter, a medium transport path from the transport roller pair 31 to a transport roller pair 32 is referred to as a recording transport path T1.

The line head 44, which is an example of the recording section, constitutes a head unit 43. The line head 44 performs recording by ejecting ink onto a surface of the medium. The line head 44 is an ink ejection head configured such that nozzles for ejecting ink cover an entire region in the medium width direction, and is configured as an ink ejection head that is capable of recording on the entire region in the medium width direction without being moved in the medium width direction. However, the ink ejection head is not limited to this, and may be of a type that is mounted on a carriage and that ejects ink while moving in the medium width direction.

The head unit 43 is provided so as to be able to advance and retreat with respect to the recording transport path T1, and is provided so as to be able to move between a recording position where the head unit 43 performs recording on a medium after advancing to the recording transport path T1, and a retreat position where the head unit 43 retreats from the recording transport path T1.

FIG. 1 shows a state in which the head unit 43 is at the recording position, and recording is performed on a medium in this state.

Reference numerals 10A, 10B, 10C, and 10D denote ink accommodation sections serving as liquid storage sections. Ink being ejected from the line head 44 is supplied to the line head 44 from each ink accommodation section via tubes (not shown). The ink accommodation sections 10A, 10B, 10C, and 10D are provided to be attachable to and detachable from mount sections 11A, 11B, 11C, and 11D, respectively.

Reference numeral 12 denotes a waste liquid container that stores ink as waste liquid that was ejected from the line head 44 toward a flushing cap (not shown) for maintenance.

The transport belt 53 is an endless belt wound around a drive shaft 51 and a driven shaft 52, and rotates when the drive shaft 51 is driven by a motor (not shown). A medium is transported to a position facing the line head 44 while being attracted to a belt surface of the transport belt 53. A known attraction method such as an air suction method or an electrostatic attraction method can be used to attract a medium onto the transport belt 53.

The recording transport path T1 that passes a position facing the line head 44 intersects both the horizontal direction and the vertical direction, and transports a medium in an upward direction. In other words, the F-axis direction intersects both the horizontal direction and the vertical direction. Thus, an ejection surface 44a that ejects ink in the line head 44 is also parallel to the F-axis direction and that intersects both the horizontal direction and the vertical direction. In this embodiment, an angle α formed between the F-axis direction and the horizontal direction is 75°. Note that the angle α may be appropriately changed to other angles in the range of 0°<α≤90°. For example, the angle α may be set in the range of 45°≤α≤80°. Note that in the case of reducing a size of the device main body 2, 60°≤α≤80° is desirable.

A medium on which recording has been performed on a first surface by the line head 44 is further sent upward by the transport roller pair 32, which is located downstream of the transport belt 53.

A flap 41 is provided downstream of the transport roller pair 32 and switches the transport direction of a medium. In a case when a medium is to be discharged as is, the flap 41 switches the transport path of the medium so that the medium directs toward the upper transport roller pair 35, and the medium is discharged by the transport roller pair 35 to the discharge tray 8, which is an example of the medium placement section.

In a case when recording is performed on a second surface of the medium in addition to the first surface, the flap 41 guides the medium to a guide path T2. In this embodiment, the guide path T2 is a medium transport path from the transport roller pair 32 to the flap 42.

The flap 42 is pressed in a counterclockwise direction in FIG. 1 by a pressing member (not shown), and a medium advancing in the guide path T2 pushes the flap 42 aside and enters a switchback path T3. In this embodiment, the switchback path T3 is a medium transport path to the upper side from the flap 42. The switchback path T3 is provided with transport roller pairs 36 and 37. A medium that has entered the switchback path T3 is transported upward by the transport roller pairs 36 and 37, when a lower end of the medium passes the flap 42, a rotation direction of the transport roller pairs 36 and 37 are switched, and by this, the medium is transported downward. At this time, the flap 42 guides a medium so that the medium being transported in the downward direction directs toward an inversion path T4.

The flap 42 is an example of a switching section that can switch between a state that guides a medium from the guide path T2 to the switchback path T3 and a state that guides a medium from the switchback path T3 to the inversion path T4.

The inversion path T4 is connected to the switchback path T3. In this embodiment, the inversion path T4 is a medium transport path from a position of the flap 42 to the transport roller pair 31 via transport roller pairs 33, 34, and 38.

A medium transported downward from the position of the flap 42 receives a feed force from the transport roller pairs 33 and 34, reaches the transport roller pair 38, is curved and inverted, and is sent to the transport roller pair 31. Note that the transport roller pair 33 is an example of a first roller pair, and the transport roller pair 34 is an example of a second roller pair. However, the transport roller pair 34 may be an example of the first roller pair, and the transport roller pair 33 may be an example of the second roller pair.

A medium is sent again to a position facing the line head 44. The second surface of the medium, which is an opposite surface to the first surface on which recording has been performed, faces the line head 44. By this, recording by the line head 44 is possible against the second surface of the medium.

Note that a feed roller 19 and a separation roller 20 provided in the vicinity of the transport roller pair 38 are a roller pair that sends a medium from a supply tray (not shown in FIG. 1).

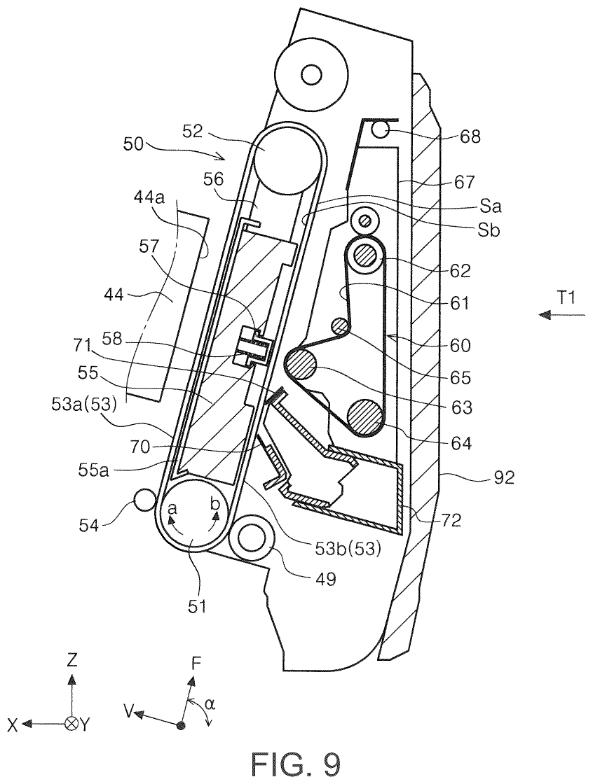

Next, a belt unit 50 and a cleaning section 60 will be described with reference to FIG. 9. The transport belt 53 constituting the belt unit 50 is an endless belt having an outer first surface Sa and an inner second surface Sb, and is wound around a drive shaft 51 and a driven shaft 52. The transport belt 53 is made of a base material such as urethane or rubber, which includes a conductive material as necessary to adjust the resistance value.

The drive shaft 51 is rotationally driven by a motor (not shown). When the drive shaft 51 is rotationally driven in a direction of arrow a, the transport belt 53 rotates in a clockwise direction in FIG. 9. Hereinafter, this rotation of the transport belt 53 may be referred to as “forward rotation.” When the drive shaft 51 is rotationally driven in a direction of arrow b, the transport belt 53 rotates in a counterclockwise direction in FIG. 9. Hereinafter, this rotation of the transport belt 53 may be referred to as “reverse rotation.”

A base frame 55 is provided inner side of the transport belt 53. A backup plate 55a is provided on the base frame 55. The backup plate 55a supports a portion of the transport belt 53 that faces the line head 44.

The base frame 55 supports a slide frame 56 so as to be slidable along the F-axis direction. The slide frame 56 supports the driven shaft 52. A pressing member, for example, a compression spring (not shown), that presses the slide frame 56 in the +F direction is provided in the base frame 55. By this, the driven shaft 52 is pressed in the +F direction, and tension is applied to the transport belt 53.

The transport belt 53 is wound around the drive shaft 51 and the driven shaft 52, and by this, a first section 53a and a second section 53b are formed as flat belt sections. The first section 53a is a section facing the line head 44, the second section 53b is a section opposite to the first section 53a.

When the transport belt 53 rotates in the forward rotation, the first section 53a of the transport belt 53 moves in the +F direction, and the second section 53b moves in the −F direction. In other words, during the forward rotation of the transport belt 53, in the first section 53a, the −F direction becomes an upstream of the belt movement direction and the +F direction becomes a downstream of the belt movement direction, and in the second section 53b, the +F direction becomes the upstream of the belt movement direction and the −F direction becomes the downstream of the belt movement direction.

When the transport belt 53 rotates in reverse, the first section 53a of the transport belt 53 moves in the −F direction, and the second section 53b moves in the +F direction. In other words, during the reverse rotation of the transport belt 53, in the first section 53a, the +F direction becomes upstream of the belt moving direction, the −F direction becomes downstream of the belt moving direction, and in the second section 53b, the −F direction becomes upstream of the belt moving direction, the +F direction becomes downstream of the belt moving direction.

A charging roller 49 is provided at a position facing the drive shaft 51 with the transport belt 53 interposed therebetween.

The charging roller 49 is in contact with the first surface Sa, which is the outer surface of the transport belt 53, and rotates in accordance with a rotation of the transport belt 53. DC voltage is applied to the charging roller 49 by a voltage applying section (not shown). By this, the charging roller 49 supplies electrical charges to a portion in contact with the transport belt 53.

In this embodiment, the charging roller 49 supplies a positive electrical charge to the transport belt 53 and charges the first surface Sa of the transport belt 53 to a positive polarity. By this, the first surface Sa of the transport belt 53 becomes an attraction surface that attracts a medium.

However, a structure for transporting a medium by the transport belt 53 is not limited to such an electrostatic attraction method, and may be another method such as an air suction method.

A support roller 54 which comes into contact with a medium is provided on an upstream side of the line head 44. The support roller 54 presses the medium against a portion of the transport belt 53 that is wound around the drive shaft 51. Note that the support roller 54 is grounded. By this, the electrical charge on the recording surface side of the medium is removed.

The cleaning section 60 is provided at a position facing the second section 53b of the transport belt 53. The cleaning section 60 has a cleaning web 61. The cleaning web 61 is wound around a drive shaft 62, a pressing shaft 63, and a driven shaft 64, and tension is applied to the cleaning web 61 by a tensioner 65.

The cleaning web 61 is an endless fabric in this embodiment, and can be pressed against the first surface Sa of the transport belt 53 by the pressing shaft 63. The drive shaft 62 is rotationally driven by a sheet drive motor (not shown). The drive shaft 62 is rotationally driven in the clockwise direction in FIG. 9. By this, the cleaning web 61 is rotated in the clockwise direction in FIG. 9.

The cleaning section 60 has a pivot frame 67. The drive shaft 62, the pressing shaft 63, and the driven shaft 64 described above are disposed on the pivot frame 67, and all members are configured as a unit body. The pivot frame 67 is provided so as to be pivotable around a pivot shaft 68, which is extending in the Y-axis direction, and pivoting of the pivot frame 67 causes the pressing shaft 63 to advance or retreat with respect to the transport belt 53.

The pivot frame 67 is pressed by a pressing member (not shown), for example, a tension spring, in a direction that the pressing shaft 63 is directed toward the transport belt 53. The pivot frame 67 can be in a state where pivoting in a direction toward the transport belt 53 is restricted by rotation of a cam (not shown) and a state in which the restriction is released. In the state where the cam restricts the pivoting of the pivot frame 67, the pressing shaft 63 is separated from the transport belt 53, and the cleaning section 60 is in a non-cleaning state where the cleaning web 61 is separated from the first surface Sa of the transport belt 53. In the state where the cam releases the restriction, the pressing shaft 63 advances to the transport belt 53 side, and the cleaning section 60 becomes a cleaning state where the cleaning web 61 comes into contact with the first surface Sa of the transport belt 53.

In the cleaning state of the cleaning section 60, the cleaning web 61 is pressed against the transport belt 53 by the pressing shaft 63. In this state, the transport belt 53 rotates in the forward rotation, and the cleaning web 61 rotates in the clockwise direction in FIG. 9, so that the first surface Sa of the transport belt 53 is cleaned. In other words, the cleaning web 61 cleans the first surface Sa by relatively moving with respect to the first surface Sa while being in contact with the first surface Sa of the transport belt 53.

Note that a backup member 57 is provided at the inner side of the transport belt 53. The backup member 57 is provided on the base frame 55 in the inner side of the transport belt 53. The backup member 57 is provided to contact the second surface Sb of the transport belt 53. The position where the backup member 57 contacts is a position on the second surface Sb side of the transport belt 53 and where the cleaning web 61 contacts the first surface Sa of the transport belt 53.

The backup member 57 nips the transport belt 53 and the cleaning web 61 between the backup member 57 and the pressing shaft 63, and assists the cleaning of the first surface Sa by the cleaning web 61.

The backup member 57 is provided in the base frame 55 so as to be displaceable in the V-axis direction and is pressed toward the second surface Sb by the compression spring 58.

A paper dust removal wiper 70 is provided in the −F direction side of the cleaning section 60. The paper dust removal wiper 70 is formed of, for example, a sheet material made of PET (polyethylene terephthalate), and is arranged in a direction that is opposite to the forward rotation direction of the transport belt 53. The paper dust removal wiper 70 is fixedly provided and constantly in contact with the transport belt 53 to remove paper dust from the transport belt 53.

Reference numeral 72 denotes a paper dust collection container that collects removed paper dust. Reference numeral 71 denotes a contact sheet that prevents paper dust, which is adhering to the paper dust removal wiper 70, from moving to the transport belt 53 and from moving to the upstream side of it, when the transport belt 53 is rotated in reverse rotation.

Note that in this embodiment, the cleaning section 60 is configured to clean the transport belt 53 by the cleaning web 61. However, instead of or in addition to this, the cleaning section 60 may be configured to clean the transport belt 53 by a blade.

Next, a door section 80 will be described.

As shown in FIGS. 1 to 3, a door section 80 is an opening and closing body that is openable and closable, and is provided on the −X direction side surface of the device main body 2, that is, a right side surface of the device main body 2.

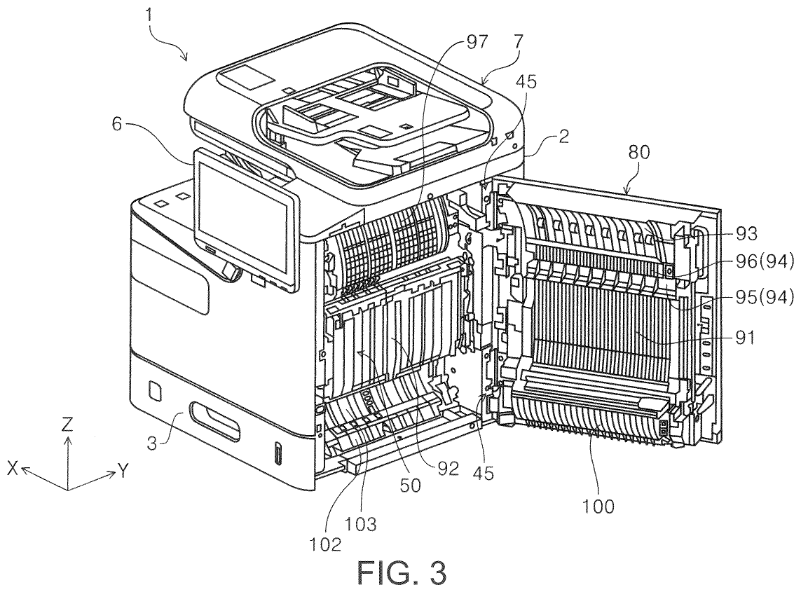

The door section 80 is pivotably connected to the device main body 2 by the hinge section 45 (see FIG. 3), and is opened and closed with respect to the device main body 2 by pivoting. In this embodiment, a pivot shaft line of the door section 80 is parallel to the Z-axis direction. In this embodiment, the door section 80 is pivotably connected to the device main body 2 at an end section in the +Y direction, and pivots with an end section in the −Y direction as a free end.

Note that the door section 80 is provided with a lock section (not shown). This lock section is engaged with an engaged section (not shown) provided on the device main body 2, so that the door section 80 is locked in a closed state with respect to the device main body 2. This lock section can be unlocked by operating an operation lever 81 (see FIG. 2).

The door section 80 forms a part of the guide path T2, a part of the switchback path T3, and a part of the inversion path T4 between the door section 80 and the device main body 2. In addition, the door section 80 forms a part of the inversion path T4 inside. When the door section 80 is opened as shown by a change from FIG. 2 to FIG. 3, inside of the device main body 2 is exposed. By this, a part of the guide path T2, a part of the switchback path T3, and a part of the inversion path T4 are opened.

When the door section 80 is opened as shown in FIG. 3, the first path forming section 91, the fourth path forming section 94, and the eighth path forming section 100 are exposed on the door section 80 side. When the door section 80 is opened, the second path forming section 92, the fifth path forming section 97, the ninth path forming section 102, and the tenth path forming section 103 are exposed on the device main body 2 side.

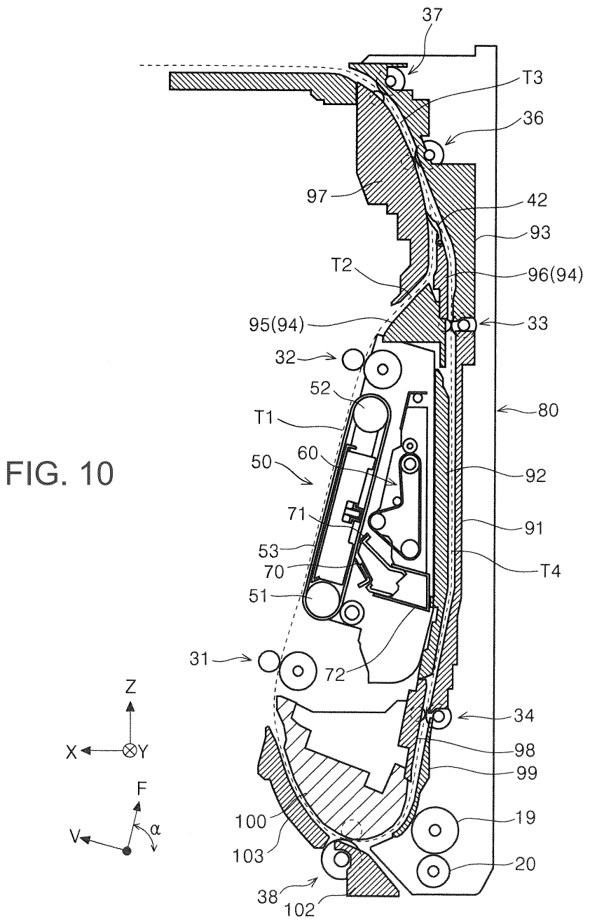

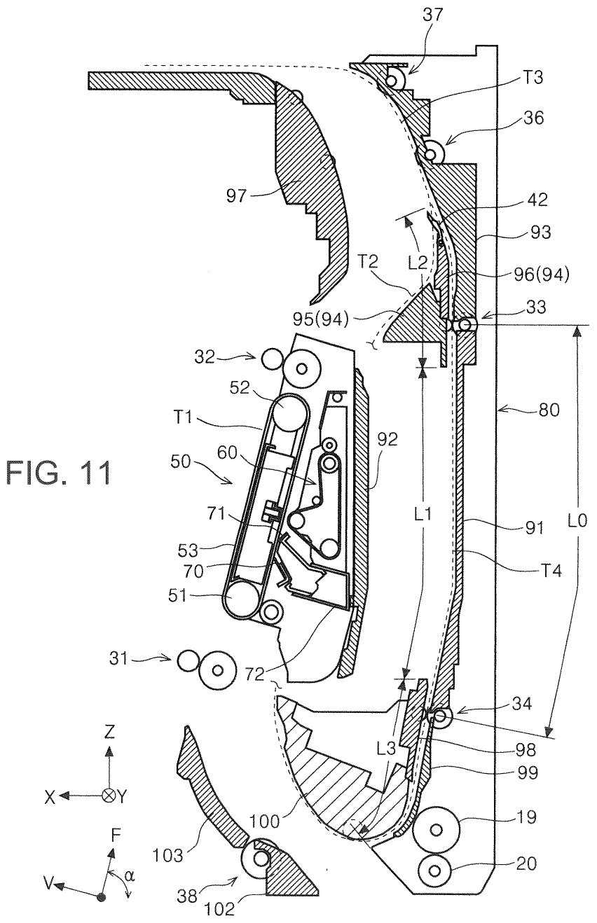

FIG. 10 and FIG. 11 show the path forming sections that form each medium transport path with hatching. Note that FIG. 10 shows a state in which the door section 80 is closed. In order to clearly show the path forming sections associated with the door section 80 when the door section 80 is opened, in FIG. 11, the path forming sections associated with the door section 80 are conveniently shifted in the −X direction from the path forming sections associated with the device main body 2.

As shown in FIGS. 10 and 11, the fourth path forming section 94 forms a part of the guide path T2. A third path forming section 93 and the fifth path forming section 97 form a part of the switchback path T3. Each of the first path forming section 91, the second path forming section 92, the third path forming section 93, the fourth path forming section 94, a sixth path forming section 98, a seventh path forming section 99, the eighth path forming section 100, the ninth path forming section 102, and the tenth path forming section 103 forms a part of the inversion path T4. Note that the fourth path forming section 94 has a first member 95 and a second member 96.

Amongst the above-described path forming sections, the first path forming section 91, the third path forming section 93, the fourth path forming section 94, the sixth path forming section 98, the seventh path forming section 99, and the eighth path forming section 100 are provided in the door section 80.

The second path forming section 92, the fifth path forming section 97, the ninth path forming section 102, and the tenth path forming section 103 are provided in the device main body 2. In particular, the second path forming section 92 is provided in the belt unit 50.

In this embodiment, each of the path forming sections is formed of a resin material.

The door section 80 includes the rollers in the −X direction side of the transport roller pairs 36 and 37, the transport roller pairs 33 and 34, the feed roller 19, the separation roller 20, and the roller in the +Z direction side of the transport roller pair 38. When door section 80 is opened, the nip of the transport roller pairs 36, 37, and 38 is released as shown in FIG. 11.

As described above, by opening the door section 80, if a jam occurs in the guide path T2, the switchback path T3, and the inversion path T4, the jammed medium can be removed.

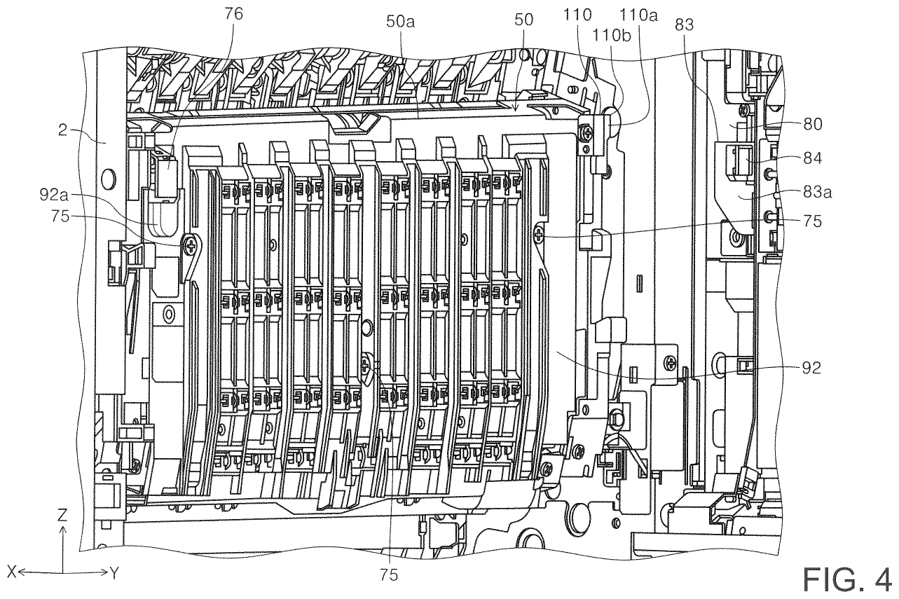

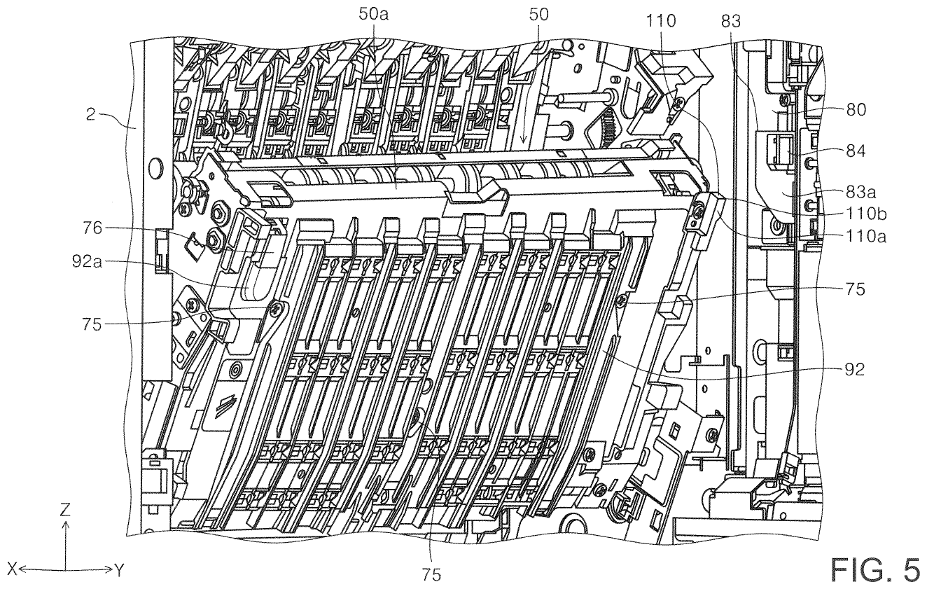

When the door section 80 is opened, as shown in FIGS. 4 and 5, the belt unit 50 as an example of the support section is exposed. The belt unit 50 is composed of various members assembled to a unit main body 50a. The unit main body 50a is pivotable around the drive shaft 51 as a pivot shaft. By pivoting, the belt unit 50 can be switched between a first state (FIG. 4) in which the belt unit 50 can support a medium on which recording is performed by the line head 44 and a second state (FIG. 5) in which the belt unit 50 retreats further from the line head 44 than is in the first state. By setting the belt unit 50 in the second state, if a jam occurs in the recording transport path T1, the jammed medium can be removed.

The second path forming section 92a is provided on the belt unit 50. In FIGS. 4 and 5, reference numerals 75 denote screws that fix the second path forming section 92 to the unit main body 50a. By removing the screws 75, the second path forming section 92 can be detached from the unit main body 50a. By this, the cleaning section 60 described above can be accessed, and for example, the paper dust collection container 72 can be attached and detached.

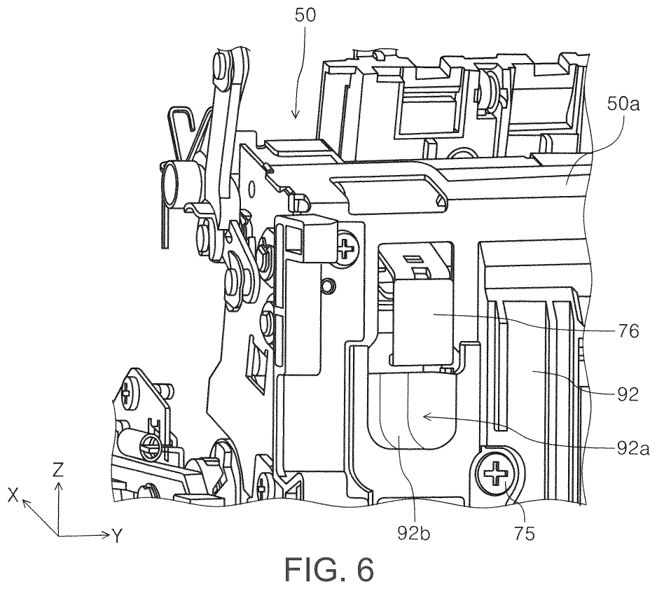

In the second path forming section 92, a recess section 92a is formed in the −Y direction side of the unit main body 50a, as shown enlarged in FIG. 6. A bottom section of the recess section 92a is formed as a guide surface 92b with a recess shape. An operation section 76 is provided above the recess section 92a to unlock the belt unit 50, which is held in the first state, that is, it is locked. The belt unit 50 has a lock mechanism (not shown) that locks the belt unit 50 in the first state. By putting a finger on the operation section 76 from below and pulling the operation section 76 in the −X direction, the lock is released, and the belt unit 50 can be switched from the first state to the second state.

The guide surface 92b, which is formed in the second path forming section 92 as a guide section, guides the user's finger to the operation section 76. Therefore, usability is improved. In addition, since the guide surface 92b is provided in the second path forming section 92, it is not necessary to provide the guide surface 92b in a dedicated member and to suppress an increase in cost of the device.

As shown in FIGS. 4 and 5, the belt unit 50 has a first section 110 in the +Y direction side with respect to the second path forming section 92. The first section 110 has a supported surface 110a.

The door section 80 is provided with a contact section 83. The contact section 83 is provided with a pressing section 84. The pressing section 84 presses the first section 110 (a supported surface 110a) of the belt unit 50 in a state where the door section 80 is closed. This press direction is a direction in which the belt unit 50 becomes the first state, that is, a closing direction.

The pressing section 84 is provided so as to be displaceable in a direction in which the pressing section 84 advances or retreats with respect to the belt unit 50, and is pressed toward the belt unit 50 by a pressing member (not shown) such as a spring. In a state where the door section 80 is closed, such a pressing section 84 properly maintains the first state of the belt unit 50.

Note that the pressing section 84 presses the belt unit 50 in the first state, that is, in the closing direction, at a +Y direction end section of the belt unit 50 in the Y-axis direction. Note that a similar pressing section 84 is also provided at a −Y direction end section of the belt unit 50, but it is omitted from the drawings.

The lock mechanism described above holds the belt unit 50 in the first state at the −Y direction end section and the +Y direction end section of the belt unit 50 in the Y-axis direction.

Here, there is a case where the door section 80 is closed while the belt unit 50 is in the second state, that is, in the open state. The contact section 83 provided on the door section 80 works in this case.

The contact section 83 has a contact surface 83a. If the door section 80 is closed while the belt unit 50 is in the second state, that is, the open state, the contact surface 83a comes into contact with a corner section 110b of the first section 110. When the door section 80 is further closed from this state, the contact surface 83a presses the first section 110, and by this, the belt unit 50 pivots in a direction of closing.

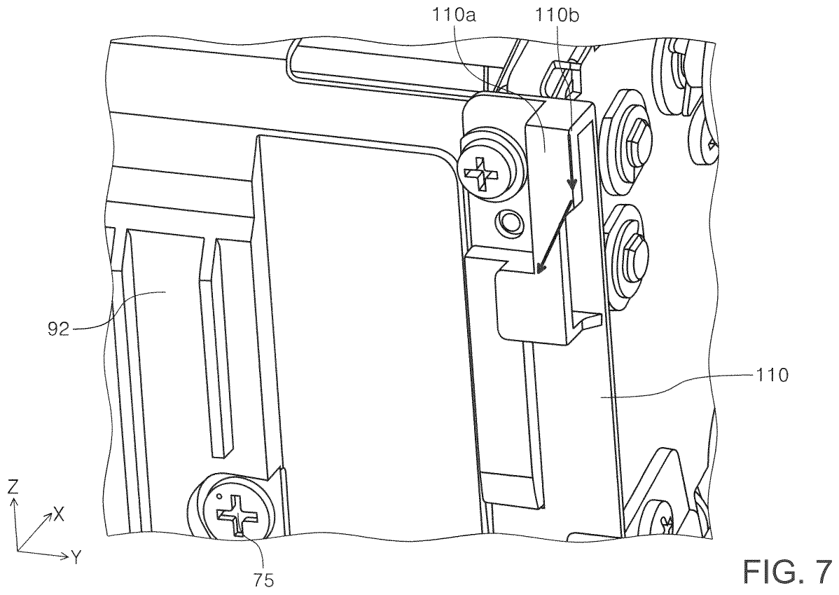

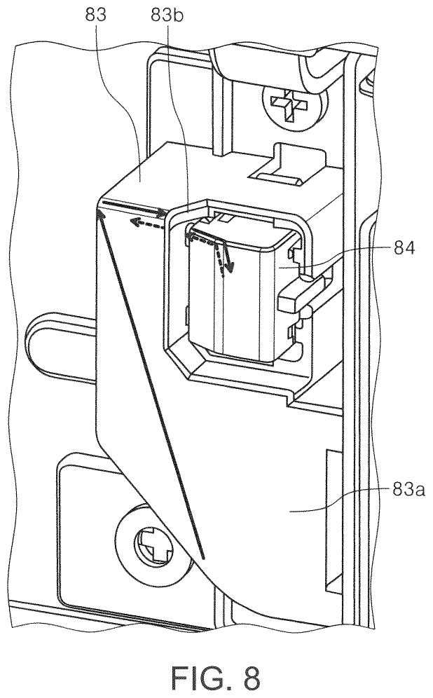

A solid arrow shown in FIG. 8 indicates a path in which the first section 110 moves on the contact surface 83a when the door section 80 is being closed. An arrow shown in FIG. 7 indicates a change in the position of the first section 110 that contacts the contact surface 83a and the pressing section 84 when the door section 80 is being closed.

As shown in FIG. 8, when the door section 80 is being closed, the first section 110 moves from a lower portion of the contact surface 83a to an upper portion of the contact surface 83a, moves from the contact surface 83a to the pressing section 84, and is pressed by the pressing section 84. In other words, when the door section 80 closes, the belt unit 50 also closes and switches to the first state.

Note that in the case where the door section 80 is opened again before it is completely closed, the first section 110 follows a reverse path of the path shown in FIG. 8 on the contact surface 83a. In the case where the door section 80 is opened again before it is completely closed, a contact position that the first section 110 is in contact with the contact surface 83a and the pressing section 84 follows the reverse of the change shown in FIG. 7.

As described above, the door section 80 has a contact section 83 that, while the door section 80 is closing from a state in which the door section 80 is open and the belt unit 50 is in the second state, switches the belt unit 50 to the first state by contacting the belt unit 50. By this, even when the door section 80 is closed while the belt unit 50 is in the second state, the door section 80 can switch the belt unit 50 from the second state to the first state. Therefore, usability is improved.

The door section 80 also has a pressing section 84 that presses the belt unit 50 toward the second state. By this, the belt unit 50 can be appropriately maintained in the first state. As a result, a distance between the belt unit 50 and the line head 44 is appropriately maintained, and a decrease in recording accuracy can be suppressed.

In accordance with the close operation of the door section 80, a state in which the contact section 83 is in contact with the belt unit 50 transitions to a state in which the pressing section 84 presses the belt unit 50. As described above, the operation of closing the door section 80 can realize the switching of the belt unit 50 to the second state and the pressing of the belt unit 50 by the pressing section 84.

In addition, the positions of the contact section 83 and the pressing section 84 can be brought closer to each other, and a size of the device can be reduced.

In this embodiment, the contact section 83 holds the pressing section 84. By this, a size of the device can be reduced compared to a configuration where the pressing section 84 is held by a dedicated member, and an increase in cost can be suppressed.

Here, when the door section 80 is about to be closed, there is a case that it is not completely closed and is opened again. In this case, the first section 110 attempts to move from a state of being in contact with the pressing section 84 to a state of being in contact with the contact section 83. However, at this time, there is concern that the first section 110 may be caught on the contact section 83. Specifically, as shown by a broken line arrow in FIG. 8, this is the case where the first section 110 attempts to move from the state of being in contact with the pressing section 84 to the state of being in contact with the contact section 83.

However, the contact section 83 according to this embodiment has a guide section 83b. When the first section 110 moves from the state of being in contact with the pressing section 84 to the state of being in contact with the contact section 83 by opening the door section 80, the guide section 83b guides the first section 110 from the pressing section 84 to the contact section 83. By this, an occurrence of the above-mentioned catching can be suppressed.

Note that as described above, the belt unit 50 has the transport belt 53, and the transport belt 53 transports a medium in the +F direction, that is, a direction intersecting the horizontal direction and the vertical direction. In a configuration in which the transport belt 53 transports a medium in a direction intersecting the horizontal direction and the vertical direction, the belt unit 50 easily pivots toward the second state due to its own weight. However, the pressing section 84 can properly maintain the belt unit 50 in the first state. As a result, a distance between the belt unit 50 and the line head 44 is appropriately maintained, and a decrease in recording accuracy can be suppressed.

Next, the each path forming section described with reference to FIGS. 10 and 11 will be further described.

As described above, the door section 80 has the first path forming section 91, which forms a part of the inversion path T4, the transport roller pair 33, and the transport roller pair 34, which is located below the transport roller pair 33. The transport roller pair 33 and the transport roller pair 34 maintain a nip state when the door section 80 is opened or closed as shown in FIG. 11, because two rollers of each roller pair, which face each other, are both provided in the door section 80.

As shown in FIG. 11, when the door section 80 is opened, at least a part of the path section between the transport roller pair 33 and the transport roller pair 34 in the inversion path T4 is opened. In this embodiment, a region of a path length L1 is opened. A path length L0 between transport roller pair 33 and transport roller pair 34 is shorter than a transport direction length of a smallest size of medium that is recordable.

As described above, the transport roller pair 33 and the transport roller pair 34 maintain a nip state when door section 80 is opened or closed, and the path length L0 between transport roller pair 33 and transport roller pair 34 is shorter than the transport direction length of a smallest size of medium that is recordable. Therefore, a medium is nipped by at least one of the transport roller pair 33 or transport roller pair 34. As a result, it is possible to suppress a medium from unintentionally falling when door section 80 is opened.

Here, when door section 80 is opened, if the path section between the transport roller pair 33 and the transport roller pair 34 in the inversion path T4 is closed over the entire region, visibility of a jammed medium is reduced, and the jammed medium is difficult to remove. However, according to this embodiment, when the door section 80 is opened, at least a part of the path section between the transport roller pair 33 and the transport roller pair 34 in the inversion path T4 is opened. Therefore, visibility of the jammed medium is improved, and the jammed medium can be easily removed. As a result, usability of the printer 1 can be improved.

The belt unit 50 has the second path forming section 92 that forms a part of the inversion path T4 at a position facing the first path forming section 91. When the door section 80 is opened, a space between the first path forming section 91 and the second path forming section 92 is opened. By this, it is possible to remove a medium jammed between the first path forming section 91 and the second path forming section 92. As a result, usability of the printer 1 can be improved.

The door section 80 has a third path forming section 93 that forms a part of the inversion path T4 at a position different from the first path forming section 91, and a fourth path forming section 94 that faces the third path forming section 93 at least a part of the third path forming section 93 and that forms a part of the transport path. The transport roller pair 33 is disposed in a part of the inversion path T4 that is formed by the third path forming section 93 and the fourth path forming section 94. In other words, one of the rollers constituting the transport roller pair 33 is provided in the third path forming section 93, and the other roller is provided in the fourth path forming section 94.

The door section 80 has the seventh path forming section 99 that forms a part of the inversion path T4 at a position different from the first path forming section 91, and the sixth path forming section 98 that faces at least a part of the seventh path forming section 99 and that forms a part of the transport path. The transport roller pair 34 is disposed in a part of the inversion path T4 formed by the seventh path forming section 99 and the sixth path forming section 98. In other words, one of the rollers constituting the transport roller pair 34 is provided in the seventh path forming section 99, and the other roller is provided in the sixth path forming section 98.

A path length L2, which is a part of the inversion path T4 formed by the third path forming section 93 and the fourth path forming section 94, is shorter than the path length L1, which is a part of the inversion path T4 formed by the first path forming section 91 and the second path forming section 92 and which is a region that is opened by opening the door section 80. By this, the following operations and effects can be obtained.

A part of the inversion path T4 that is formed by the third path forming section 93 and the fourth path forming section 94 is a section that is not opened even when the door section 80 is opened. In this embodiment, the path length L2, which is a section that is not opened even when the door section 80 is opened, is shorter than the path length L1, which is a section that is opened by opening the door section 80. Therefore, it is possible to secure the visibility of a jammed medium while suppressing the medium from falling when the door section 80 is opened. As a result, usability of the device can be improved.

In this embodiment, the path length L2, which is a part of the inversion path T4 that is formed by the third path forming section 93 and the fourth path forming section 94, is shorter than the transport direction length of a smallest size of medium that is recordable. By this, regardless of the transport direction length of medium, a medium jammed between the third path forming section 93 and the fourth path forming section 94 can be visually recognized and removed. As a result, usability of the printer 1 can be improved.

Note that in this embodiment, a part of the inversion path T4 that is formed by the sixth path forming section 98, the seventh path forming section 99, and the eighth path forming section 100 in the door section 80 is also a section that is not opened even when the door section 80 is opened, similarly to the above.

In this embodiment, this section, that is a path length L3, is shorter than the path length L1, which is the section that is opened by opening the door section 80. By this, visibility of a jammed medium can be ensured while suppressing a medium from falling when the door section 80 is opened. As a result, usability of the device can be improved.

A section where a medium is curved and inverted, that is, a section formed by the eighth path forming section 100, is divided as shown in FIG. 11. Therefore, when a jam occurs in the section where the medium is curved and inverted, the jammed medium can be easily removed.

The path length L3 is also shorter than the transport direction length of the smallest size of medium that is recordable. By this, regardless of the transport direction length of the medium, a medium that is jammed in the section of the path length L3 can be visually recognized and removed. As a result, usability of the printer 1 can be improved.

The medium transport path of the printer 1 has the switchback path T3, which performs a switchback transport of a medium that has passed between the line head 44 and the belt unit 50, the guide path T2, which guides a medium that has passed between the line head 44 and the belt unit 50 to the switchback path T3, and the inversion path T4, which is connected to the switchback path T3 and inverts a medium. The fourth path forming section 94 forms at least a part of the guide path T2 and at least a part of the inversion path T4. The first path forming section 91 and the second path forming section 92 form at least a part of the inversion path T4 at a downstream side from the third path forming section 93 in the transport direction.

The fourth path forming section 94 forms at least a part of the guide path T2 and at least a part of the inversion path T4. Therefore, it is possible to reduce a size of the device by sharing the same the members. As a result, the printer 1 can be easily handled, and usability of the printer 1 can be improved.

Next, the fourth path forming section 94 will be described in detail.

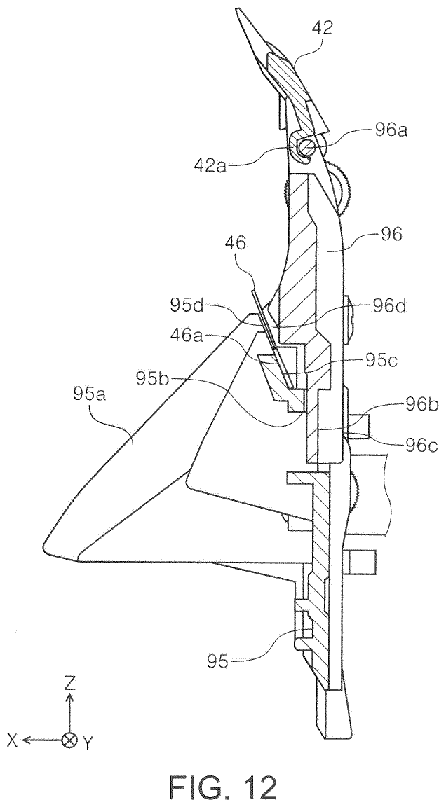

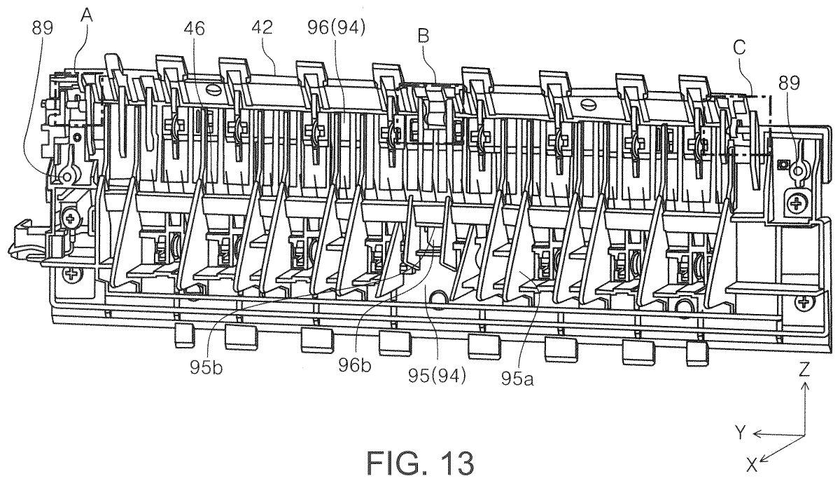

As shown in FIGS. 12 and 13, the fourth path forming section 94 has a first member 95 and a second member 96 that is connected to the first member 95. The second member 96 is fixed to the first member 95 by screws 89 at both end sections in the medium width direction. The first member 95 is provided with path forming ribs 95a at appropriate intervals along the medium width direction. The path forming ribs 95a form the guide path T2.

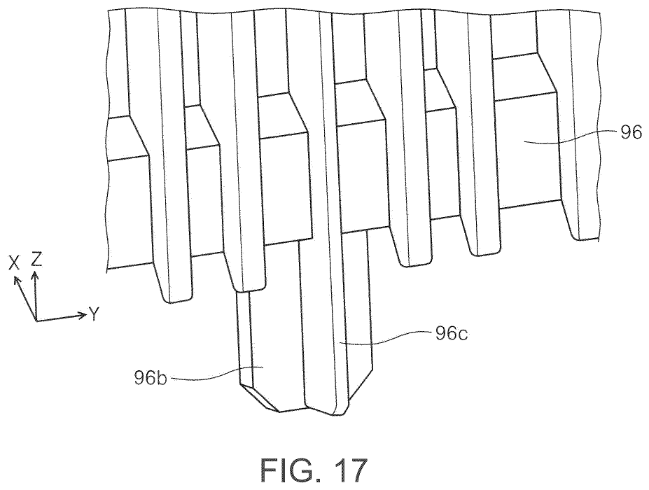

As shown in FIG. 17, a plate-shaped section 96b, which is protruding in the downward direction, is formed in the second member 96. The first member 95 has an insertion section 95b into which the plate-shaped section 96b can be inserted in the downward direction. By inserting the plate-shaped section 96b into the insertion section 95b, in the central portion of the medium width direction, the second member 96 is restricted so as not to move in the X-axis direction with respect to the first member 95.

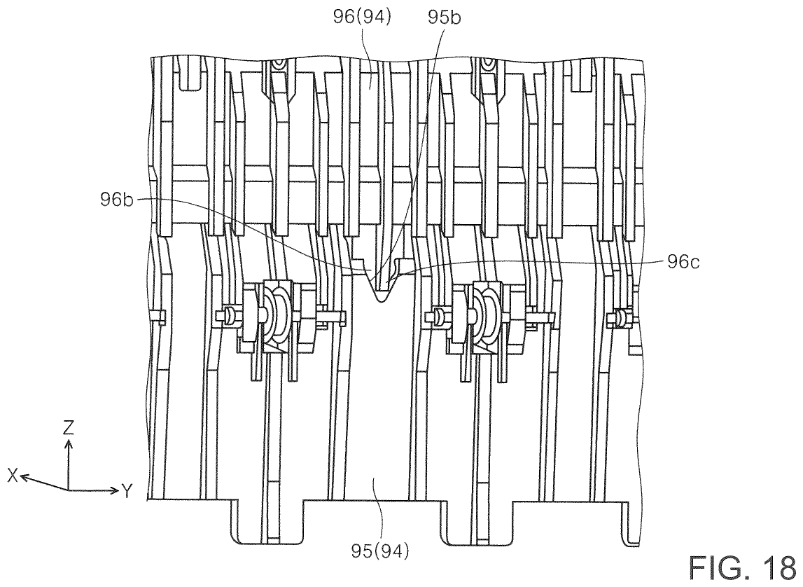

Note that the plate-shaped section 96b has a guide rib 96c. The guide rib 96c, in a state where the plate-shaped section 96b is inserted into the insertion section 95b as shown in FIG. 18, guides a medium so that the leading edge of the medium being transported in the inversion path T4 does not get caught in the second member 96. As described above, a medium is guided by the guide rib 96c that is provided in the plate-shaped section 96b that restricts a movement of the second member 96. By this, the medium can be transported stably without complicating the configuration.

As shown in FIGS. 12 and 13, a charge removal brush 46 is provided in the fourth path forming section 94. The charge removal brush 46 is an example of a charge elimination section and removes charge from a medium, in the guide path T2. The charge removal brush 46 is provided in a state of being sandwiched between the first member 95 and the second member 96.

In FIG. 12, a base section 46a of the charge removal brush 46 can be fixed to an attachment surface 95c, which is formed on the first member 95, by a double-sided tape, adhesive material, or the like. When the second member 96 is fixed to the first member 95 while the base section 46a of the charge removal brush 46 is attached to the attachment surface 95c, the charge removal brush 46 enters a state that of being sandwiched between a gripping section 95d of the first member 95 and a gripping section 96d of the second member 96.

In this way, the charge removal brush 46 is provided in a state of being sandwiched between the first member 95 and the second member 96. Therefore, the charge removal brush 46 can be easily assembled.

Note that instead of fixing the base section 46a of the charge removal brush 46 to the attachment surface 95c that is formed on the first member 95 with a double-sided tape or adhesive material, the charge removal brush 46 may be fixed by sandwiching it between the gripping section 95d of the first member 95 and the gripping section 96d of the second member 96.

The base section 46a of the charge removal brush 46 may be fixed to the second member 96 with a double-sided tape, adhesive material, or the like, then may be sandwiched between the first member 95 and the second member 96.

Next, the attachment structure of the flap 42 to the second member 96 will be described.

As shown in FIGS. 13 to 16, a plurality of support shaft sections 96a are provided on an upper portion of the second member 96 at intervals along the medium width direction. The support shaft sections 96a serves as a pivot shaft of the flap 42.

The flap 42 has a first engagement section 42a and a second engagement section 42b that can engage with the support shaft section 96a. The flap 42 is pivotably engaged with the support shaft section 96a by sandwiching the support shaft section 96a between the first engagement section 42a and the second engagement section 42b.

The plurality of the first engagement sections 42a and the second engagement sections 42b are provided along the medium width direction.

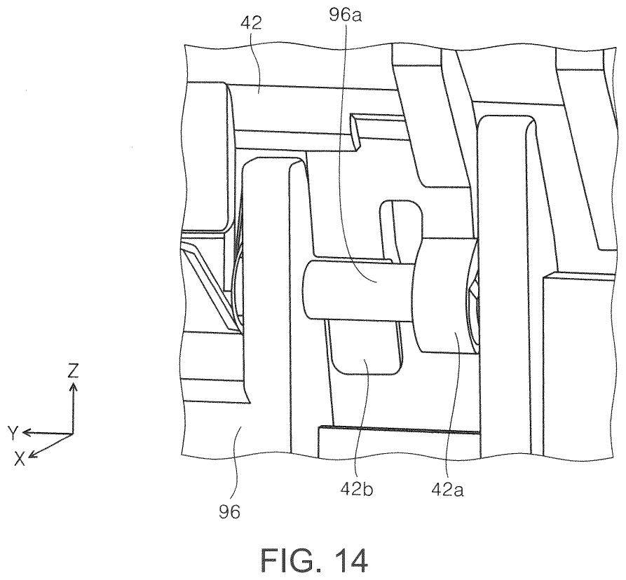

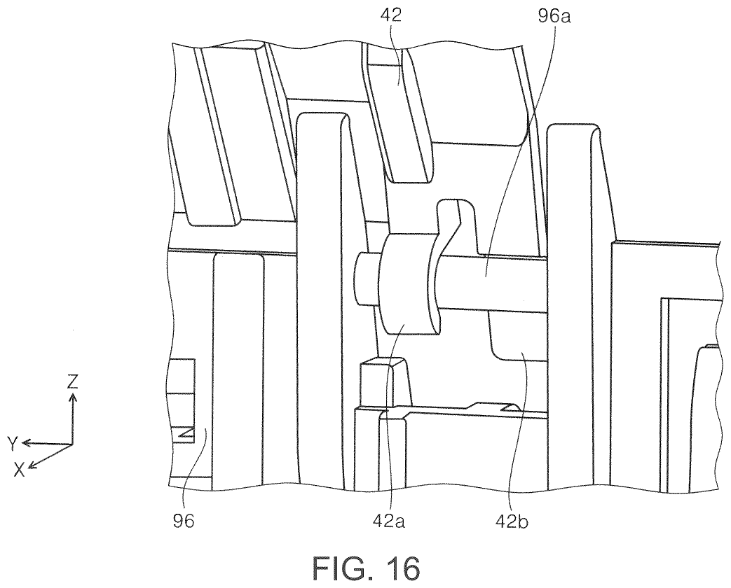

At both end sections in the medium width direction, both the first engagement sections 42a and the second engagement sections 42b are provided, as shown in FIGS. 14 and 16. The first engagement sections 42a and the second engagement sections 42b sandwich the support shaft sections 96a. The first engagement section 42a is formed in a recess shape so as to receive the support shaft section 96a.

The first engagement section 42a restricts a movement of the flap 42 in a first direction in which a medium comes into contact with the flap 42, that is, in the −X direction in this embodiment. The second engagement section 42b restricts a movement of the flap 42 in a second direction that is opposite to the first direction, that is, in the +X direction in this embodiment.

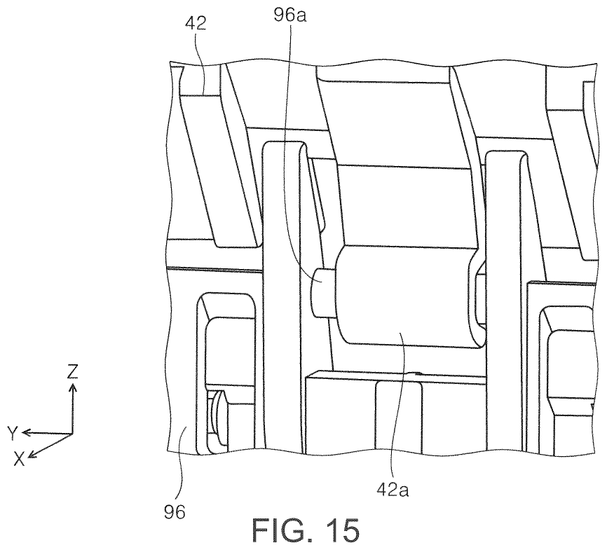

As shown in FIGS. 12 and 15, the second engagement section 42b is not provided at the central section in the medium width direction. In other words, the number of the second engagement sections 42b is smaller than the number of the first engagement sections 42a.

If the number of the second engagement section 42b and the number of the first engagement section 42a were the same, the workability of engaging the flap 42 to the support shaft sections 96a would be reduced. In addition, there is concern that friction resistance when the flap 42 is fitted to the support shaft sections 96a will increase and smooth swinging of the flap 42 may not be ensured.

However, in this embodiment, the number of the second engagement sections 42b is smaller than the number of the first engagement sections 42a. Therefore, it is possible to suppress a decrease in workability when engaging the flap 42 to the support shaft sections 96a, and it is possible to suppress an increase in friction resistance when the flap 42 is being fitted to the support shaft sections 96a.

There is concern that the flap 42 will deform in the −X direction when the medium comes into contact with the flap 42. However, the first engagement sections 42a are provided at the center and both ends of the flap 42 in the medium width direction, so that the above deformation can be suppressed.

Note that in this embodiment, the transport belt 53 transports a medium in the +F direction, that is, in a direction that intersects the horizontal direction and the vertical direction. By this, the printer 1 can reduce a size of the printer 1 in the horizontal direction and the vertical direction.

Since the belt unit 50 is pivotable, accessibility to the transport belt 53 is improved, and usability is improved.

In this embodiment, the belt unit 50 has a cleaning section 60 that performs cleaning of the transport belt 53. As viewed in a direction intersecting the outer surface of the door section 80, that is, in a direction of arrow T1 in FIG. 9, the transport belt 53 and the cleaning section 60 enter a region of the second path forming section 92. By this, it is possible to suppress the user from carelessly accessing the transport belt 53 or the cleaning section 60, and soiling their fingers. In addition, it is not necessary to provide a dedicated member that covers the transport belt 53 and the cleaning section 60, and it is possible to suppress an increase in a cost of the device.

The cleaning section 60 has a paper dust collection container 72 that collects paper dust from the transport belt 53. As viewed in a direction intersecting the outer surface of the door section 80, that is, in the direction of arrow T1 in FIG. 9, the second path forming section 92 covers the paper dust collection container 72. By this, when the door section 80 is opened, it is possible to suppress the user from carelessly accessing the paper dust collection container 72 and scattering the paper dust. In addition, it is not necessary to provide a dedicated member that covers the paper dust collection container 72, and it is possible to suppress an increase in a cost of the device.

The present disclosure is not limited to the embodiments and the modifications described above, and various modifications can be made within the scope of the disclosure described in the claims, and it is needless to say that these are also included in the scope of the present disclosure.

What is claimed is:

1. A recording device comprising:
a device main body having a transport path in which a medium is transported and a recording section that performs recording on a medium in the transport path; and
a door section that opens and closes a side surface of the device main body, and that opens a part of the transport path by being opened and that forms a part of the transport path by being closed, wherein
the door section has
a first path forming section that forms a part of the transport path,
a first roller pair that nips and transports a medium, and
a second roller pair that is located below or above the first roller pair and that nips and transports a medium,
the first roller pair and the second roller pair maintain a nipped state when the door section is opened or closed,
when the door section is opened, at least a part of a path section between the first roller pair and the second roller pair is opened in the transport path, and
a path length between the first roller pair and the second roller pair is shorter than a transport direction length of a smallest size of medium that is recordable.

2. The recording device according to claim 1, wherein
the device main body has a support section that is provided at a position facing the recording section and that is configured to support a medium on which recording is performed by the recording section,
the support section has a second path forming section that forms a part of the transport path at a position facing the first path forming section, and
by the door section being opened, a space between the first path forming section and the second path forming section is opened.

3. The recording device according to claim 2, wherein
the door section has
a third path forming section that forms a part of the transport path at a position different from the first path forming section and
a fourth path forming section that at least partly faces the third path forming section and forms a part of the transport path, and
the first roller pair is disposed in a part of the transport path that is formed by the third path forming section and the fourth path forming section.

4. The recording device according to claim 3, wherein
a path length of the part of the transport path that is formed by the third path forming section and the fourth path forming section is shorter than a path length of a part of the transport path that is formed by the first path forming section and the second path forming section and that is opened by opening the door section.

5. The recording device according to claim 3, wherein
a path length of the part of the transport path that is formed by the third path forming section and the fourth path forming section is shorter than a transport direction length of a smallest size of medium that is recordable.

6. The recording device according to claim 3, wherein
the transport path has
a switchback path that is used for switchback transport of a medium that passed between the recording section and the support section,
a guide path that guides the medium that passed between the recording section and the support section to the switchback path, and
an inversion path that is connected to the switchback path and that inverts the medium,
the fourth path forming section forms at least a part of the guide path and at least a part of the inversion path, and
the first path forming section and the second path forming section form at least a part of the inversion path at a downstream side of the third path forming section in the transport direction.

7. The recording device according to claim 6, wherein
the fourth path forming section has
a first member and
a second member that is connected to the first member, and
a charge removal brush that removes charge from a medium is provided in a state of being sandwiched between the first member and the second member.

8. The recording device according to claim 6, further comprising:
a switching section that is configured to switch between a state in which a medium is guided from the guide path to the switchback path and a state in which a medium is guided from the switchback path to the inversion path, wherein
the fourth path forming section has a plurality of support shaft sections that pivotably support the switching section along the medium width direction that intersects a medium transport direction,
the switching section has
a first engagement section that restricts movement of the switching section in a first direction, where the medium comes into contact with the switching section, by engaging with the support shaft sections and
a second engagement section that restricts movement of the switching section in a second direction, which is an opposite direction to the first direction, by engaging with the support shaft sections,
the switching section is pivotably engaged with the support shaft sections by sandwiching the support shaft sections between the first engagement section and the second engagement section,
the first engagement section and the second engagement section are provided in plurality along the medium width direction, and
the number of the second engagement sections is less than the number of the first engagement sections.

9. The recording device according to claim 6, further comprising:
a switching section that is configured to switch between a state in which a medium is guided from the guide path to the switchback path and a state in which a medium is guided from the switchback path to the inversion path, wherein
the fourth path forming section has a plurality of support shaft sections that pivotably support the switching section along the medium width direction that intersects a medium transport direction,
the switching section has
a first engagement section that restricts movement of the switching section in a first direction, where the medium comes into contact with the switching section, by engaging with the support shaft sections and
a second engagement section that restricts movement of the switching section in a second direction, which is an opposite direction to the first direction, by engaging with the support shaft sections,
the switching section is pivotably engaged with the support shaft sections by sandwiching the support shaft sections between the first engagement section and the second engagement section,
the first engagement section and the second engagement section are provided in plurality along the medium width direction,
the first engagement sections are provided at a center and both ends of the switching section in the medium width direction, and
the second engagement sections are provided at both ends of the switching section in the medium width direction.

10. The recording device according to claim 2, wherein
the support section
is configured to switch by pivoting between a first state in which the support section is configured to support a medium to be recorded on by the recording section and a second state in which the support section is further retracted from the recording section than in the first state and
has an operation section that releases a state of holding the support section in the first state, and
the second path forming section has a guide section that guides a user's finger to the operation section.

11. The recording device according to claim 10, wherein
the support section has a transport belt that transports a medium and
the transport belt transports a medium in a direction that intersects with a horizontal direction and a vertical direction.

12. The recording device according to claim 2,
the support section has a transport belt that transports a medium.

13. The recording device according to claim 12, wherein
the support section has a cleaning section that performs cleaning of the transport belt and
as viewed in a direction that intersects with an outer surface of the door section, the transport belt and the cleaning section enter into a region of the second path forming section.

14. The recording device according to claim 13, wherein
the cleaning section has a paper dust collection container that collects paper dust from the transport belt and
as viewed in a direction that intersects the outer surface of the door section, the second path forming section covers the paper dust collection container.

15. The recording device according to claim 2, wherein
the support section is configured to switch by pivoting between a first state in which the support section is configured to support a medium to be recorded on by the recording section and a second state in which the support section is further retracted from the recording section than in the first state and
the door section has a contact section that switches the support section to the first state by contacting the support section while the door section is closing from a state in which the door section is open and the support section is in the second state.

16. The recording device according to claim 2, wherein
the support section is configured to switch by pivoting between a first state in which the support section is configured to support a medium to be recorded on by the recording section and a second state in which the support section is further retracted from the recording section than in the first state and
the door section has a pressing section that presses the support section toward the first state.

17. The recording device according to claim 16, wherein
the door section has a contact section that switches the support section to the first state by contacting the support section while the door section is closing from a state in which the door section is open and the support section is in the second state and
in conjunction with a close operation of the door section, the contact section transitions from a state in which the contact section is in contact with the support section to a state in which the pressing section presses the support section.

18. The recording device according to claim 17, wherein
the contact section holds the pressing section.

19. The recording device according to claim 17, wherein
the support section has a first section that engages with the contact section and the pressing section and
the door section has a guide section that guides the first section from the pressing section to the contact section when the door section is opened and the first section transitions from a state in which the first section is in contact with the pressing section to a state in which the first section comes into contact with the contact section.

20. The recording device according to claim 17, wherein
the support section has a transport belt that transports a medium and
the transport belt transports a medium in a direction that intersects with a horizontal direction and a vertical direction.
